(19) United States
(12) Patent Application Publication
(10) Pub. No.: US 2004/0060398 A1
(43) Pub. Date: Apr. 1, 2004

(54) Hand tool having pivotable function end

(76) Inventor: Chih-Ching Hsien, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/254,593

(22) Filed: Sep. 26, 2002

(51) Int. Cl. B25B 23/16; B25G 1/00

(52) U.S. Cl. 81/177.7

(57) ABSTRACT

A hand tool includes a shank that has a function end pivotably connected to an end of the shank and the function end is able to engage an object to be tightened or loosened. The function end is able to be pivoted relative to the shank so as to access the object at any angle.

### FIELD OF THE INVENTION

The present invention relates to a hand tool that has a adjustable wrench at one end and a pivotable function end on the other end so as to access the object at any angle.

### BACKGROUND OF THE INVENTION

A conventional hand tool generally includes a shank and a function end is connected to one end of the shank. The function end can be a wrench, a ratchet wrench or any type of known function end. The function end is fixed to the shank and cannot be pivoted relative to the shank so that the tool has to be put perpendicularly to the axis of the screw to be tightened or loosened so that the function end can engage with the head of the screw. Nevertheless, in some situations, the screw to be tightened or loosened is located deep in a recess or there are other objects located beside the screw, the conventional hand tool is not able to access the screw successfully.

The present invention intends to provide a hand tool that has a pivotable function end so as to be used at angle relative to the shank.

### SUMMARY OF THE INVENTION

In accordance with one aspect of the present invention, there is provided a hand tool which comprises a shank having a protrusion extending from an end thereof and a pivotable function end which has two lugs extending from an end thereof and the protrusion is pivotably connected between the two lugs.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the pivotable function end and the hand tool of the present invention;

FIG. 2 is a perspective view to show the hand tool of the present invention;

FIG. 3 shows the pivotable function end is pivoted relative to the shank;

FIG. 4 shows the pivotable function end is pivoted and engaged with a bolt, and

FIG. 5 shows the engaging member in the pivotable function end includes two stepped polygonal insides in each side of the engaging member.

### DETAILED DESCRIPTION OF THE PREFERRED EMBODIMENT

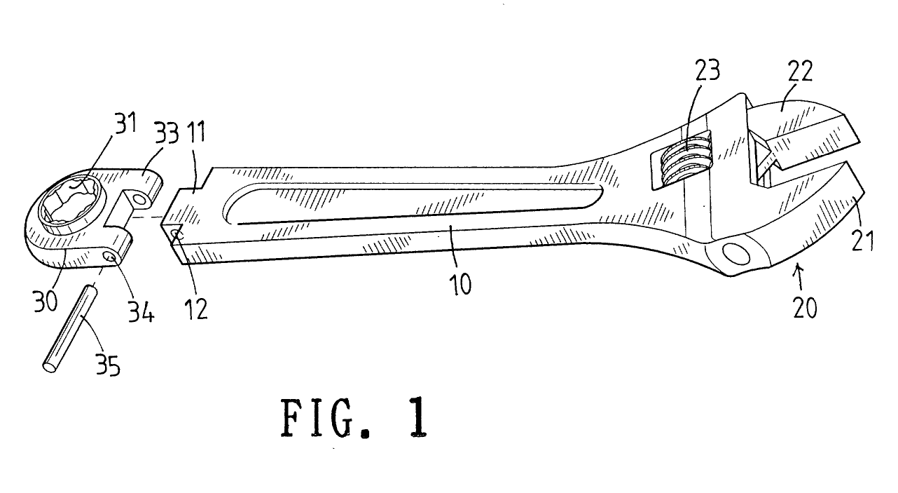

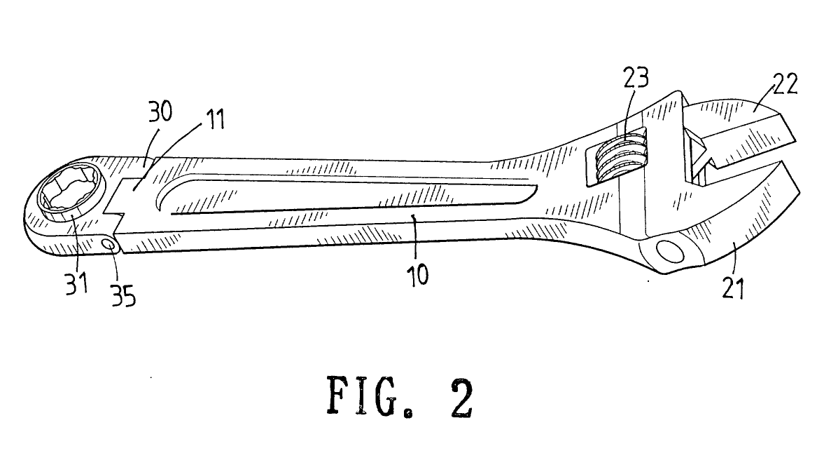

Referring to FIGS. 1 and 2, the hand tool of the present invention comprises a shank 10 having adjustable wrench 20 on a first end thereof and the adjustable wrench 20 has a fixed jaw 21 and a movable jaw 22 which is controlled by a adjusting screw 23.

A protrusion 11 extends from a second end of the shank 10 and a passage 12 is defined through the protrusion 11. A pivotable function end 30 such as a ratchet box end has two lugs 33 extending from an end thereof and the protrusion 11 is pivotably connected between the two lugs 33 by a pin 35 extending through two respective holes 34 in the two lugs 33 and the passage 12 in the protrusion 11.

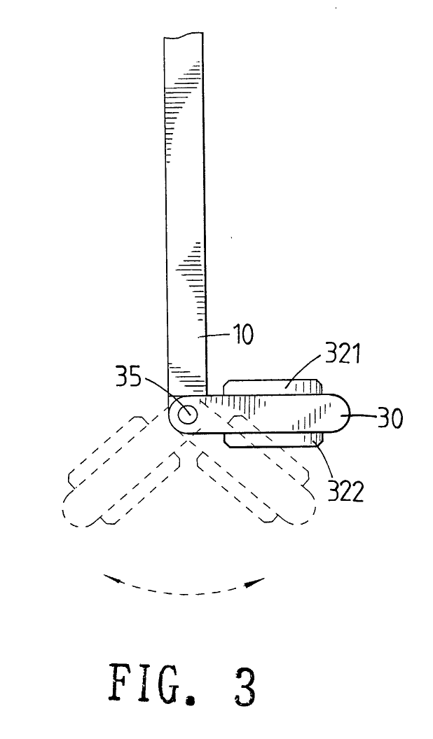

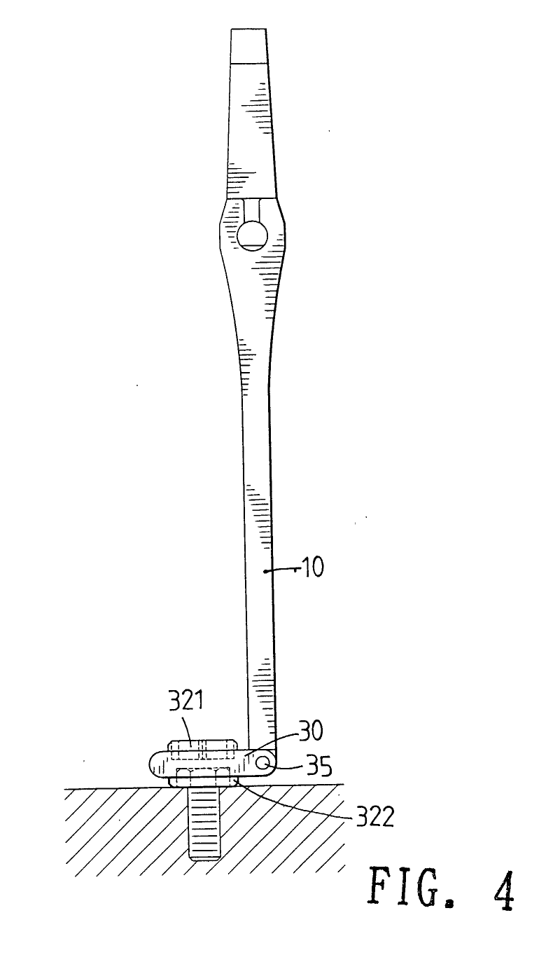

The function end 30 has a hole defined therethrough and an engaging member 31 is rotatably engaged with the hole. The engaging member 31 has an engaging hole so as to engage with a head of a bolt as shown in FIG. 4. The engaging hole includes two different sizes of polygonal insides 321, 322 so as to engaging two bolts of different sizes. The pivotable function end 30 can be pivoted at an angle relative to the shank 10 as shown in FIG. 3 and can access to the bolt conveniently.

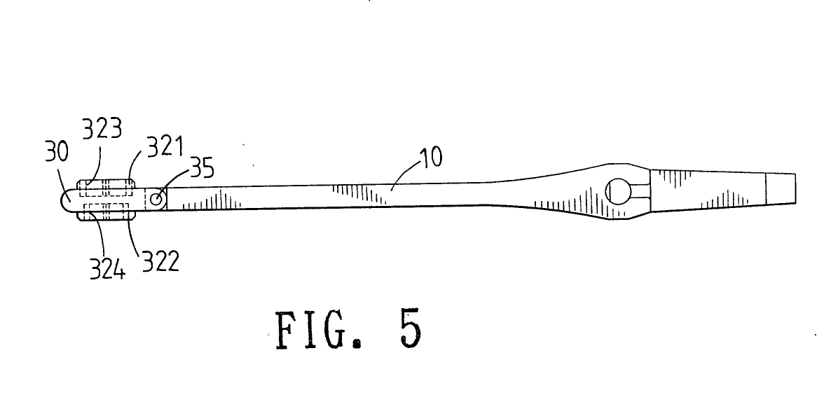

Referring to FIG. 5, The engaging hole of the engaging member 31 includes at least two stepped polygonal insides 321, 323, and 322, 324 in each side thereof. By the arrangement, the pivotable function end 30 can engage with at least four different sizes of bolts.

While we have shown and described the embodiment in accordance with the present invention, it should be clear to those skilled in the art that further embodiments may be made without departing from the scope of the present invention.

What is claimed is:

1. A hand tool comprising:
a shank having a protrusion extending from an end thereof, and
a pivotable function end having two lugs extending from an end thereof and the protrusion being pivotably connected between the two lugs.

2. The hand tool as claimed in claim 1, wherein the function end has a hole defined therethrough and an engaging member is rotatably engaged with the hole, the engaging member having an engaging hole.

3. The hand tool as claimed in claim 2, wherein the engaging hole of the engaging member includes at least two stepped polygonal insides in each side thereof.
